(19) United States
(12) Patent Application Publication
(10) Pub. No.: US 2001/0028226 A1
(43) Pub. Date: Oct. 11, 2001

(54) Twin capacitor pixel driver circuit for micro displays

(76) Inventors: Shashi D. Malaviya, Hopewell Junction, NY (US); Hongjin Kim, Bedford, MA (US)

Correspondence Address: COLLIER, SHANNON, SCOTT, PLLC, 3050 K STREET, NW, SUITE 400, WASHINGTON, DC, 20007, US

(21) Appl. No.: 09/784,020

(22) Filed: Feb. 16, 2001

Related U.S. Application Data
(60) Provisional application No. 60/183,361, filed on Feb. 18, 2000.

(51) Int. Cl. G09G 3/10

(52) U.S. Cl. 315/169.3; 315/160

(57) ABSTRACT

The present invention is directed to a circuit and method of reducing unwanted coupled noise in an OLED video display device. Input analog data are magnified to a range of about +3.3 V (for minimum pixel current) to about +0.8 V (for maximum pixel current). The magnified input analog data are then fed to the data line (230). A pair of capacitors (200, 210) bring the data back to the original range of about 0 V to about 0.7 V. The attenuated data are fed by a pixel driver (130) to the pixel (100). The pair of capacitors functions as a voltage divider, and as a result, the coupled noise constitutes a smaller percentage of the input data, and the display image is cleaner.

### CROSS REFERENCE TO RELATED APPLICATIONS AND ASSERTION OF SMALL ENTITY STATUS

This application relates to and claims priority on U.S. Provisional Application Ser. No. 60/183,361, filed Feb. 18, 2000 and entitled “Twin Capacitor Pixel Driver Circuit For Micro Displays.” Applicants hereby assert that they are a small entity as described under 37 C.F.R. § 1.27 and are therefore entitled to a reduction in fees associated with the filing of this application.

### FIELD OF THE INVENTION

The present invention relates to a driver circuit for organic light emitting diode (OLED) micro displays. In particular, the present invention is directed to a twin capacitor pixel driver circuit that attenuates input analog data in order to reduce unwanted coupled noise.

### BACKGROUND OF THE INVENTION

Organic light emitting devices have been known for approximately two decades. OLEDs work on certain general principles. An OLED is typically a laminate formed on a substrate such as soda-lime glass or silicon. A light-emitting layer of a luminescent organic solid, as well as adjacent semiconductor layers, are sandwiched between a cathode and an anode. The light-emitting layer may be selected from any of a multitude of luminescent organic solids, and may consist of multiple sublayers or a single blended layer of such material. The cathode may be constructed of a low work function material while the anode may be constructed from a high work function material. Either the OLED anode or the cathode (or both) should be transparent in order to allow the emitted light to pass through to the viewer. The semiconductor layers may include hole-injecting or electron-injecting layers.

When a potential difference is applied across the device (from cathode to anode), negatively charged electrons move from the cathode to the electron-injecting layer and finally into the layer(s) of organic material. At the same time positive charges, typically referred to as holes, move from the anode to the hole-injecting layer and finally into the same organic light-emitting layer(s). When the positive and negative charges meet in the organic material, they produce photons.

The wave length—and consequently the color—of the photons depends on the material properties of the organic material in which the photons are generated. The color of light emitted from the OLED can be controlled by the selection of the organic material, or by the selection of dopants, or by other techniques known in the art. Different colored light may be generated by mixing the emitted light from different OLEDs. For example, white light may be produced by mixing the light from blue, red, and yellow OLEDs simultaneously.

In a matrix-addressed OLED device, numerous individual OLEDs may be formed on a single substrate and arranged in groups in a grid pattern. Several OLED groups forming a column of the grid may share a common cathode, or cathode line. Several OLED groups forming a row of the grid may share a common anode, or anode line. The individual OLEDs in a given group emit light when their cathode line and anode line are activated at the same time. A group of OLEDs within the matrix may form one pixel in a display, with each OLED usually serving as one subpixel or pixel cell.

OLEDs have a number of beneficial characteristics. These include: a low activation voltage (about 5 volts); fast response when formed with a thin light-emitting layer; high brightness in proportion to the injected electric current; high visibility due to self-emission; superior impact resistance; and ease of handling. OLEDs have practical application in television, graphic display systems, and digital printing. Although substantial progress has been made in the development of OLEDs to date, additional challenges remain.

For example, OLED display images are subject to degradation from extraneous electrical signals known as “coupled noise.” Coupled noise results in a loss of grade shades in the display image, and therefore, a poorer quality image. The voltage range in the analog input data line of a typical OLED pixel cell containing a single capacitor is generally between 0 V to 0.7 V, for a maximum pixel current of about twenty nano-amps. Typically, the input line is long (because it has to cover the entire array of pixel cells) and runs in close proximity to a large number of fast switching digital lines. The input line therefore picks up a considerable amount of coupled noise.

A well-known method for reducing coupled noise is to protect the line with AC grounded shielding lines located above, below and on the two sides of the line to form a “coaxial” structure. This shielding causes a loss in wiring density, however, which translates to a loss in pixel density, and consequently, a lower resolution of the display image. Generally, such a loss in wiring density is unacceptable even if the line is only partially shielded.

Accordingly, there is a need for an OLED display having a method of minimizing the coupled noise that does not reduce wiring density. As disclosed in the present invention, input analog voltage in a data driver are magnified by a factor of 2× to 5× before being fed to the data line. As a result, the coupled noise that is inevitably present makes up a much smaller percentage of the input data. After the incoming data reach the pixel cell, they are attenuated by using a pair of capacitors to bring them back to the original range of 0 to 0.7 V.

The present invention meets the needs set forth above, and provides other benefits as well.

### OBJECTS OF THE INVENTION

It is therefore object of the present invention to provide an OLED display with a cleaner image.

It is another object of the present invention to provide an OLED display having magnified analog input data so that the coupled noise voltage constitutes a only a small fraction of the total data.

It is still another object of the present invention to provide an OLED display with a method of attenuating the coupled noise in a long data input line.

It is yet another object of the present invention to provide an OLED display with a method of attenuating coupled noise that uses a pair of capacitors to bring the data back to their original voltage range.

It is a further object of the present invention to provide an OLED display with a method of reducing coupled noise that does not reduce wiring density.

It is still a further object of the present invention to provide a direct view OLED display with a method of attenuating coupled noise.

It is yet a further object of the present invention to provide an OLED micro display with a method of attenuating coupled noise.

Additional objects and advantages of the invention are set forth, in part in the description which follows and, in part, will be apparent to one of ordinary skill in the art from the description and/or from the practice of the invention.

### SUMMARY OF THE INVENTION

In response to the foregoing challenge, Applicants have developed an innovative, economical circuit and method of reducing unwanted coupled noise in an OLED display device. The present invention is directed to a pixel driver circuit for an organic light emitting diode (OLED) video display device having a plurality of pixels arranged in a matrix, wherein the driver circuit feeds magnified analog input data, having a voltage ranging from about +3.3 volts to about +0.8 volts, to a data line to drive one of the plurality of pixels. The improvement of the present invention comprises a means for attenuating the analog input data to a range of about 0 volts to about +0.7 volts, whereby a reduction in coupled noise is produced. In an embodiment of the present invention, the attenuating means may comprise a first capacitor and a second capacitor. The first capacitor and the second capacitor may operate together as a voltage divider to reduce the voltage of the magnified input data to a fractional quantity, wherein the fractional quantity of the voltage drives one of the plurality of pixels.

In accordance with the present invention, the pixel driver circuit for an organic light emitting diode (OLED) video display device having a plurality of pixels arranged in a matrix, wherein each of the plurality of pixels has an anode and a cathode, may comprise a data line for receiving magnified analog input data, having a voltage ranging from about +3.3 volts to about +0.8 volts at an input node I; a first transistor, having a gate connected to a negative row line, a source connected to the data line at the input node I, and a drain; a second transistor, having a gate connected to a node B, a source connected to a first positive power supply, and a drain connected to a node C; a third transistor for driving one of the plurality of pixels, having a gate connected to the node C, a source connected to a second positive power supply, and a drain connected to the anode of one of the plurality of pixels at a node D; a first capacitor, having a first end connected to the first transistor drain at a node A, and a second end connected to the node C and to the gate of the third transistor; a second capacitor, having a first end connected to the second transistor drain and a second end connected to the second transistor source; wherein the first capacitor and the second capacitor operate together as a voltage divider to reduce the voltage of the magnified input data to a range of about 0 volts to about +0.7 volts; and the reduced voltage input data are fed by the third transistor to one of the plurality of pixels.

In this embodiment of the present invention, the input node I has a voltage, the node A has a voltage, the node B has a normal positive voltage, the third transistor has a threshold voltage, the first positive power supply has a voltage and the second positive power supply has a voltage. The node B may be brought down to about a zero voltage from the normal positive voltage in order to turn on the second transistor, whereby the second capacitor is discharged, and simultaneously the input node I voltage may be held at about +3.3 volts in order to turn on the first transistor, whereby the first capacitor is also discharged.

Also in accordance with the present invention, a difference between the first positive power supply voltage and the second positive power supply voltage may be made equal to the third transistor threshold voltage, so that when the second capacitor is discharged, the third transistor is on the verge of conduction, and the first capacitor and the second capacitor operate together as a voltage divider to cause a fraction of the node A voltage to be fed to the node C and thence to the third transistor to drive one of the plurality of pixels. As embodied herein, the voltage divider reduces a quantity of coupled noise in comparison with a quantity of the magnified analog input data, in order to produce a cleaner image in the OLED video display device.

The present invention is also directed to a method of reducing coupled noise in an organic light emitting diode (OLED) video display device having a plurality of pixels arranged in a matrix, wherein each of the plurality of pixels has an anode and a cathode. The method may comprise the steps of providing magnified analog input data, ranging from about +3.3 volts to about +0.8 volts, to a data line at an input node I; reducing a positive voltage at a node B to about zero volts in order to turn on a second transistor; discharging a second capacitor by means of the second transistor; simultaneously holding a voltage at the input node I to about +3.3 volts in order to turn on a first transistor; discharging a first capacitor by means of the first transistor; making a voltage difference between a first positive power supply voltage and a second positive power supply voltage equal to a threshold voltage of a third transistor, so that when the second capacitor is discharged, the third transistor is on the verge of conduction; operating the first capacitor and the second capacitor together as a voltage divider; attenuating the magnified analog input data by means of the voltage divider to a voltage ranging from about 0 volts to about +0.7 volts; feeding the attenuated analog input data to the third transistor; and driving the attenuated analog input data by means of the third transistor to the anode of one of the plurality of pixels.

### BRIEF DESCRIPTION OF THE DRAWINGS

The invention will now be described in conjunction with the following drawings in which like reference numerals designate like elements and wherein:

FIG. 1 is a diagram of a twin capacitor driver circuit in accordance with the present invention.

### DETAILED DESCRIPTION OF PREFERRED EMBODIMENTS

Reference will now be made in detail to preferred embodiments of the present invention, examples of which are illustrated in the accompanying drawings.

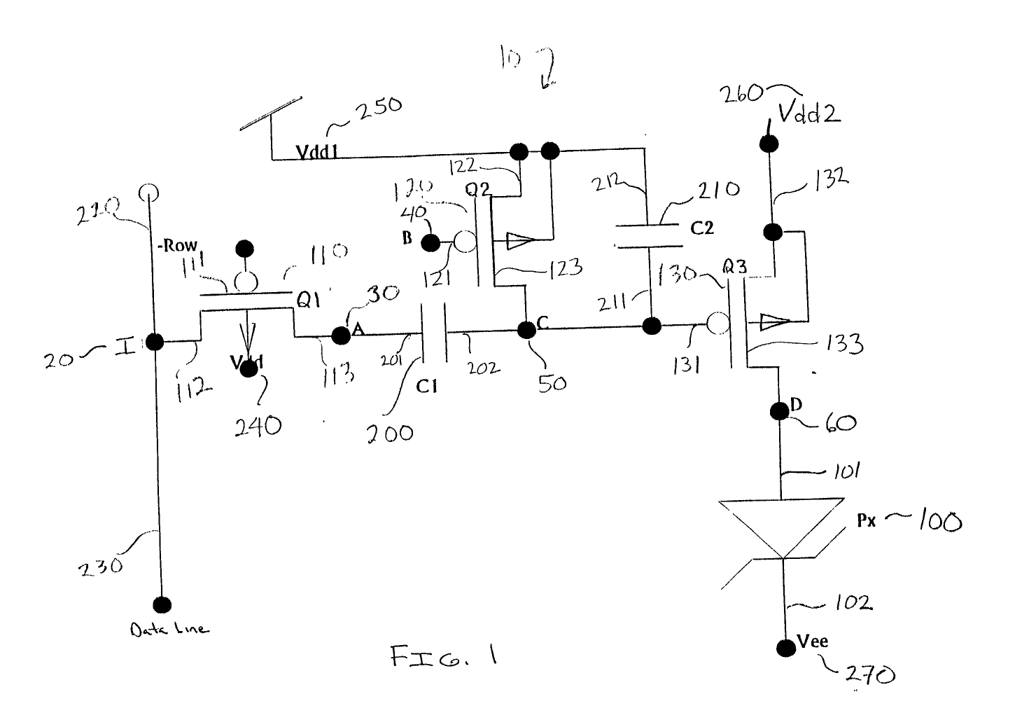

Referring now to FIG. 1, an embodiment of a driver circuit according to the present invention is shown as 10. As embodied herein, the driver circuit 10 comprises data line 230, which is connected at node I 20 to the source 112 of a P-type MOS Q1 110. The gate 111 of Q1 110 is tied to the -Row line 220 and its drain 113 (node A 30) is connected to first end 201 of a capacitor C1 200. The second end 202 of C1 200 is tied to the node C 50, which is also connected to the gate 131 of the pixel driver, a P-type MOS labeled Q3 130. The source 132 of Q3 130 is tied to a +4V supply labeled Vdd2 260. The drain 133 of Q3 130 is connected at the node D 60 to the anode 101 of the OLED Px 100. The cathode 102 of Px 100 is connected to a negative power supply Vee 270 which is typically about −7 V.

A second capacitor C2 210 is connected across the source and drain of another P-type MOS labeled Q2 120. The first end 211 of the capacitor C2 210 is connected to the drain 123 of Q2 120, and the second end 212 of the capacitor C2 210 is connected to the source 122 of Q2 120. In addition, the drain 123 of Q2 120 is connected to the node C 50 and the source 122 of Q2 120 is connected to the positive supply Vdd1 250 (+3.3V).

As embodied herein, driver circuit 10 operates as follows: prior to being fed to data line 230, the analog input data are magnified 2× to 5× times by an external source. The magnified analog input data are referenced to the +3.3V Vdd1 250 supply so that they range from +3.3 V (for minimum pixel current) to +0.8 V (for maximum pixel current). As a result, coupled noise voltage in the circuit makes up only a small fraction of the total data. The data are available at the node I 20. The difference between Vdd1 250 and Vdd2 260 is made equal to the threshold voltage of Q3 130 so that when C2 210 is discharged, Q3 130 is on the verge of conduction. The gate 121 of Q2 120 is tied to the node B 40, which is normally held at +3.3V but is brought down to about zero volt momentarily to turn on Q2 120 and discharge C2 210. Simultaneously, the input voltage at I 20 is held at +3.3V and Q1 110 is turned on to discharge C1 200 also. After discharging C1 200 and C2 210, the magnified analog voltage is fed to the data line 230. A fraction of the voltage at the node A 30 now appears at the node C 50 by the voltage divider action of capacitors C1 200 and C2 210. The attenuated input data are then fed to pixel 100 to produce light.

As embodied herein, the gate capacitance of Q3 130 becomes a part of C2 210 for computing the voltage division. Since the gate capacitance varies during the switching of Q3 130, the external capacitance C2 210 should be made much larger than the gate capacitance to minimize errors in the voltage division.

The known art circuits employ a single capacitor, equivalent to capacitor C2 210 of the present invention. As a result, the analog voltage range in the prior art circuits would be limited to about 700 mV and the data would be contaminated with coupled noise in the input line.

In contrast, the present invention provides significant reductions in noise. For example, a typical analog signal amplitude in accordance with the present invention may be 500 mV and the line noise may be 10 mV. The data are therefore contaminated with 2% noise. The analog signal is magnified by 5× to 2500 mV; the magnified data are still contaminated with 10 mV of line noise. The signal is then attenuated by 5×. The data are back to 500 mV and the accompanying noise is reduced to 2 mV, i.e., only 0.4% of the signal. The net result is a reduction of noise from 2% to 0.4%.

In accordance with the present invention, it is possible to merge Vdd1 250 and Vdd2 260 into a single +3.3V power supply. In this case, the input analog data are prebiased to about +2.6V to hold Q3 130 on the verge of conduction when the input corresponds to minimum brightness. One drawback of this option is the shrinkage of the dynamic input data range by about 0.7 V. This variation, however, eliminates the Vdd2 260 power supply. Furthermore, there is no need to maintain a precise difference of 0.7 V (the threshold voltage of Q3 130) between Vdd1 250 and Vdd2 260 in spite of their normal tolerances and voltage fluctuations. The line voltage drops in Vdd1 250 and Vdd2 260 over the surface of the pixel array are another source of error which will impact the minimum brightness levels quite significantly, depending upon the locations of the individual pixels in the array.

While this invention has been described in conjunction with specific embodiments thereof, it is evident that many alternatives, modifications and variations will be apparent to those skilled in the art. For example, the technique disclosed here is applicable to both direct view and micro displays. Accordingly, the preferred embodiments of the invention as set forth herein are intended to be illustrative, not limiting. Various changes may be made without departing from the spirit and scope of the invention.

What is claimed is:

1. A pixel driver circuit for an organic light emitting diode (OLED) video display device having a plurality of pixels arranged in a matrix, wherein said driver circuit feeds magnified analog input data, having a voltage ranging from about +3.3 volts to about +0.8 volts, to a data line to drive one of said plurality of pixels, the improvement comprising:
means for attenuating said analog input data to a range of about 0 volts to about +0.7 volts, whereby a reduction in coupled noise is produced.

2. The driver circuit of claim 1, wherein said attenuating means comprises a first capacitor and a second capacitor.

3. The driver circuit of claim 2, wherein said first capacitor and said second capacitor operate together as a voltage divider to reduce said voltage of said magnified input data to a fractional quantity, wherein said fractional quantity of said voltage drives one of said plurality of pixels.

4. A pixel driver circuit for an organic light emitting diode (OLED) video display device having a plurality of pixels arranged in a matrix, each pixel having an anode and a cathode, comprising:
a data line for receiving magnified analog input data, having a voltage ranging from about +3.3 volts to about +0.8 volts at an input node I;
a first transistor, having a gate connected to a negative row line, a source connected to said data line at said input node I, and a drain;
a second transistor, having a gate connected to a node B, a source connected to a first positive power supply, and a drain connected to a node C;
a third transistor for driving one of said plurality of pixels, having a gate connected to said node C, a source connected to a second positive power supply, and a drain connected to said anode of one of said plurality of pixels at a node D;
a first capacitor, having a first end connected to said first transistor drain at a node A, and a second end connected to said node C and to said gate of said third transistor;
a second capacitor, having a first end connected to said second transistor drain and a second end connected to said second transistor source;
wherein said first capacitor and said second capacitor operate together as a voltage divider to reduce said voltage of said magnified input data to a range of about 0 volts to about +0.7 volts; and
wherein said reduced voltage input data are fed by said third transistor to one of said plurality of pixels.

5. The pixel driver circuit of claim 4, wherein said input node I has a voltage, said node A has a voltage, said node B has a normal positive voltage, said third transistor has a threshold voltage, said first positive power supply has a voltage and said second positive power supply has a voltage.

6. The pixel driver circuit of claim 5, wherein said node B is brought down to about a zero voltage from said normal positive voltage in order to turn on said second transistor, whereby said second capacitor is discharged, and simultaneously said input node I voltage is held at about +3.3 volts in order to turn on said first transistor, whereby said first capacitor is also discharged.

7. The pixel driver circuit of claim 6, wherein a difference between said first positive power supply voltage and said second positive power supply voltage is made equal to said third transistor threshold voltage, so that when said second capacitor is discharged, said third transistor is on the verge of conduction, and said first capacitor and said second capacitor operate together as a voltage divider to cause a fraction of said node A voltage to be fed to said node C and thence to said third transistor to drive one of said plurality of pixels.

8. The pixel driver circuit of claim 7, wherein said voltage divider reduces a quantity of coupled noise in comparison with a quantity of said magnified analog input data, in order to produce a cleaner image in said OLED video display device 9. A method of reducing coupled noise in an organic light emitting diode (OLED) video display device having a plurality of pixels arranged in a matrix, each of said plurality of pixels having an anode and a cathode, comprising the steps of:
providing magnified analog input data, ranging from about +3.3 volts to about +0.8 volts, to a data line at an input node I;
reducing a positive voltage at a node B to about zero volts in order to turn on a second transistor;
discharging a second capacitor by means of said second transistor;
simultaneously holding a voltage at said input node I to about +3.3 volts in order to turn on a first transistor;
discharging a first capacitor by means of said first transistor;
making a voltage difference between a first positive power supply voltage and a second positive power supply voltage equal to a threshold voltage of a third transistor, so that when said second capacitor is discharged, said third transistor is on the verge of conduction;
operating said first capacitor and said second capacitor together as a voltage divider;
attenuating said magnified analog input data by means of said voltage divider to a voltage ranging from about 0 volts to about +0.7 volts;
feeding said attenuated analog input data to said third transistor; and
driving said attenuated analog input data by means of said third transistor to node of one of said plurality of pixels.
